(19) United States
(12) Patent Application Publication
(10) Pub. No.: US 2010/0011997 A1
(43) Pub. Date: Jan. 21, 2010

(54) DOCKABLE COMPUTER STATION

(75) Inventor: Ray Hancock, Glendale, CA (US)

Correspondence Address: DAVIS WRIGHT TREMAINE LLP/Los Angeles, 865 FIGUEROA STREET, SUITE 2400, LOS ANGELES, CA, 90017-2566, US

(73) Assignee: CEDARS-SINAI MEDICAL CENTER, Los Angeles, CA (US)

(21) Appl. No.: 12/446,732

(22) PCT Filed: Nov. 8, 2007
(86) PCT No.: PCT/US07/84127

§ 371 Date: Apr. 22, 2009

Related U.S. Application Data
(60) Provisional application No. 60/865,138, filed on Nov. 9, 2006.

(51) Int. Cl. A47B 37/00; B62B 3/00; B01L 9/02

(52) U.S. Cl. 108/50.02; 280/651; 312/209

(57) ABSTRACT

The invention relates to a mobile cart adapted to engage with an item of stationary furniture and/or to other mobile carts. In one embodiment, the mobile cart contains one or more units configured to interact when the mobile cart and stationary item of furniture are secured to one another. In another embodiment, the mobile cart is a work station adapted to be moved among different locations.

### FIELD OF THE INVENTION

The present invention relates to a mobile cart adapted to engage with an item of stationary furniture and/or to other mobile carts. In one embodiment, the mobile cart is a workstation adapted to be moved among different locations. In another embodiment, the mobile cart is a work station adapted for connecting to a computer for charging, uploading information, and/or downloading information.

### BACKGROUND OF THE INVENTION

The following description includes information that may be useful in understanding the present invention. It is not an admission that any of the information provided herein is prior art or relevant to the presently claimed invention, or that any publication specifically or implicitly referenced is prior art.

In many different settings and for a wide variety of reasons, the efficient use of space can be critical. In some settings, space is an extremely valuable commodity as little of it exists, and in still other settings, the efficient and effective use of space can be directly related to safety for the persons inhabiting that space.

Simply by way of example, in various healthcare settings, physical space can be limited; sometimes, extremely limited. For instance, in a hospital environment, there can be numerous items of equipment, rapidly moving personnel, patient beds, and the like that crowd rooms, hallways, and other physical spaces. The operating room is merely one example of a room in a hospital setting where the efficient use of space is critical, and where the appropriate or inappropriate use of that space can have a direct impact on the safety of those working within that space or being operated upon. If equipment or other items overly crowd the operating room, personnel may trip and stumble, they might be limited in their ability to freely move about the room to discharge their duties during surgery, and a host of other complications may arise. Other areas in a hospital or other healthcare settings can face related challenges.

Of course, these issues are not limited to healthcare settings. Offices, schools, manufacturing facilities, warehouses, residential spaces, hotels, airports, courthouses, fire stations and any number of other public or private buildings, facilities or exterior physical spaces are confronted by the challenges of most efficiently and effectively making use of space. Although in some cases this might relate to safety, it can additionally or alternatively have financial implications, impact the placement of furniture, alter the attractiveness of the appearance of a space or simply amount to a matter of convenience. Regardless, the fact remains that systems and methods useful in more effectively and efficiently making use of physical space would be useful.

### SUMMARY OF THE INVENTION

Various embodiments provide a mobile cart adapted to interlock with an item of stationary furniture. The item of stationary furniture can be a desk, cabinet, bookcase, credenza, table, and/or countertop. The mobile cart can also be adapted to interlock with one or more other mobile carts, and can further comprise one or more wheels, wheel locking and/or braking devices, and an interlocking device to removably secure the mobile cart to the stationary furniture. The interlocking device can be a lock, a clasp, a hook and eye, a snap, and/or a hook and loop system. The stationary furniture can also be configured to receive the mobile cart. The mobile cart can be configured to create a unitary desktop surface when interlocked with one or more other mobile carts and/or with the item of furniture, and a rectangular and/or cubic configuration is formed when the item of stationary furniture is interlocked with the mobile cart. The mobile cart can also comprise one or more units configured to removable interact with one or more corresponding receivers on the item of stationary furniture. The unit can be a power plug to provide electricity to a device on the mobile cart with the corresponding receiver as a power socket, wherein the unit is a network adapter to enable electronic communication with a device on the mobile cart and the corresponding receiver is a network jack, and/or wherein the unit is a telephone connector to enable telephonic communication with a device on the mobile cart and the corresponding receiver is a telephone jack.

Further embodiments provide an item of stationary furniture adapted to interlock with a mobile cart. The item of stationary furniture can be a desk, cabinet, bookcase, credenza, table, and/or countertop. The item of stationary furniture can further comprise an interlocking device to removably secure the item of stationary furniture to the mobile cart, which can be a lock, a clasp, a hook and eye, a snap, and/or a hook and loop system. The item of stationary furniture can also be configured to create a unitary desktop surface when interlocked with the mobile cart, and a rectangular and/or cubic configuration can be formed when the stationary furniture is interlocked with the mobile cart. The item of stationary furniture can further comprise one or more receivers configured to removably interact with one or more corresponding units on the mobile cart. The item of stationary furniture can further comprise a receiver which is a power socket and a corresponding unit as a power plug to provide electricity to a device on the mobile cart, wherein the receiver is a network jack and the corresponding unit is a network adapter to enable electronic communication with a device on the mobile cart, and/or wherein the receiver is a telephone jack and the corresponding unit is a telephone connector to enable telephonic communication with a device on the mobile cart.

Further embodiments include a system, comprising a mobile cart, an item of stationary furniture, and a computer or item of equipment useful in a healthcare setting, wherein the mobile cart is configured to interlock with the item of stationary furniture through an interlocking device, and the computer or item of equipment useful in a healthcare setting is configured in or on the mobile cart. The item of equipment useful in a healthcare setting can be a patient monitoring equipment or equipment used in performing a surgical procedure.

Other features and advantages of the invention will become apparent from the following detailed description, taken in conjunction with the accompanying drawings, which illustrate, by way of example, various embodiments of the invention.

### BRIEF DESCRIPTION OF THE FIGURES

Exemplary embodiments are illustrated in referenced figures. It is intended that the embodiments and figures disclosed herein are to be considered illustrative rather than restrictive.

FIG. 1 depicts a mobile cart and a stationary item of furniture in accordance with an embodiment of the present invention.

FIG. 2 depicts a mobile cart in accordance with an embodiment of the present invention, including a device to removably secure the mobile cart, a computer that resides on the cart, a unit to interact with a receiver of a stationary item of furniture or other mobile cart, and wheels with a locking and/or braking device.

FIG. 3 (a)-(c) depicts multiple mobile carts and a stationary item of furniture in accordance with an embodiment of the present invention.

FIG. 4 depicts multiple mobile carts and a stationary item of furniture in accordance with an embodiment of the present invention.

FIG. 5 (a)-(b) depicts a mobile cart and a stationary furniture in accordance with an embodiment of the present invention. (a) depicts the stationary item of furniture with a countertop portion that remains substantially hidden from view with a mobile cart docked to the furniture. (b) depicts the stationary item of furniture of (a), but with the mobile cart removed from the furniture. When the mobile cart is removed, the countertop portion becomes exposed, replacing the surface portion of the mobile cart.

### DESCRIPTION OF THE INVENTION

All references cited herein are incorporated by reference in their entirety as though fully set forth. Unless defined otherwise, technical and scientific terms used herein have the same meaning as commonly understood by one of ordinary skill in the art to which this invention belongs.

One skilled in the art will recognize many methods and materials similar or equivalent to those described herein, which could be used in the practice of the present invention. Indeed, the present invention is in no way limited to the methods and materials described. Exemplary embodiments are illustrated in referenced figures. It is intended that the embodiments and figures disclosed herein are to be considered illustrative rather than restrictive.

The present invention relates to systems and methods that enable one to more efficiently and effectively make use of space.

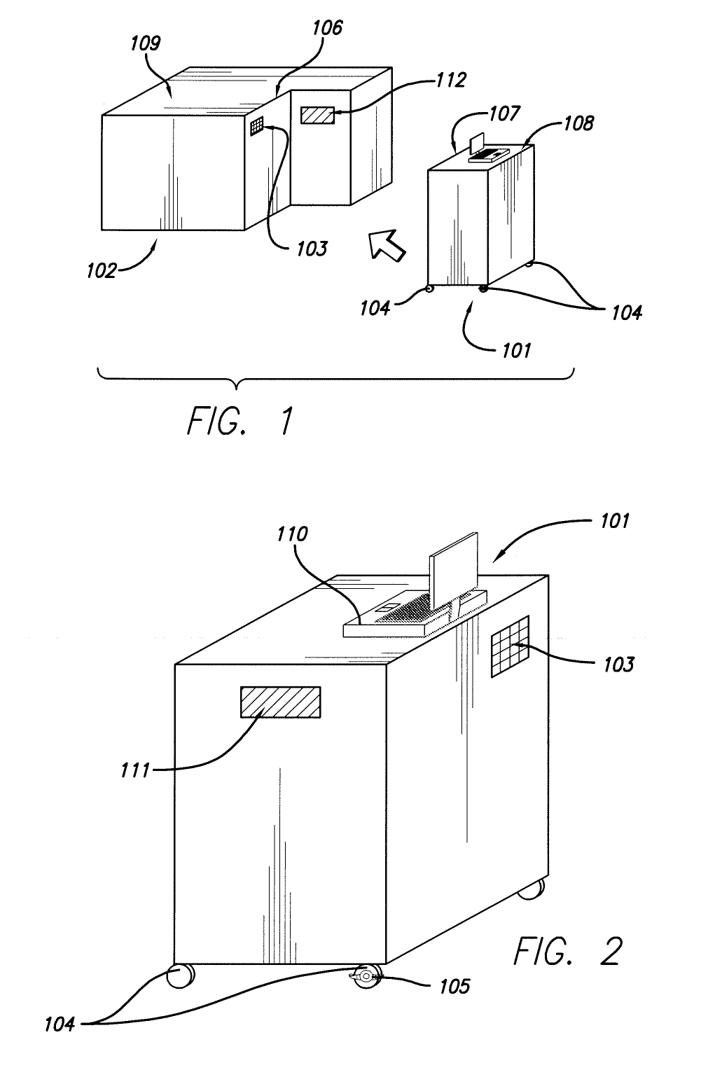

In one embodiment, as depicted in FIGS. 1 and 2, the invention includes a mobile cart 101 and a stationary item of furniture 102. The stationary item of furniture 102 may be any item of furniture, such as, but in no way limited to, a desk, cabinet, bookcase, credenza, table, countertop, or any other item of furniture. The stationary item of furniture 102 may be freestanding, may be affixed to another item (not shown), or may be built into a wall or other physical structure (not shown).

The mobile cart 101 may be adapted to interact with the stationary item of furniture 102. This interaction may take the form of a device 103 to removably secure the mobile cart 101 to the stationary item of furniture 102, including, but in no way limited to, a lock, a clasp, a hook and eye, a snap, a hook and loop system (e.g., Velcro™) and/or any other mechanical element or elements that enable one to removably secure the mobile cart 101 to the stationary item of furniture 102. A wide array of such devices 103 are commercially available and will be readily identifiable by those of skill in the art, and can be used in connection with alternate embodiments of the present invention without undue experimentation. Any number of such devices 103 may be used in alternate configurations of the present invention; for instance, several devices may be included (not shown) on various surfaces of the mobile cart 101 to interact with corresponding surfaces of the furniture 102. In one embodiment, the mobile cart 101 is a workstation adapted to be moved among different locations. In another embodiment, the mobile cart 101 is a work station adapted for connecting to a computer for charging, uploading information, and/or downloading information.

In one embodiment, the mobile cart 101 is adapted to interact with one or more other mobile carts (not shown). As with the stationary item of furniture 102, this interaction may take the form of a device 103 to removably secure the mobile cart 101 to the one or more other mobile carts, including, but in no way limited to, a lock, a clasp, a hook and eye, a snap, a hook and loop system (e.g., Velcro™) and/or any other mechanical element or elements that enable one to removably secure the mobile cart 101 to the one or more other mobile carts. A wide array of such devices 103 are commercially available and will be readily identifiable by those of skill in the art, and can be used in connection with alternate embodiments of the present invention without undue experimentation.

The mobile cart 101 may include one or more wheels 104 or similar transportation-facilitating mechanisms to provide mobility. The number and configuration of such one or more wheels 104 or similar mechanisms can vary based on the size, shape, weight and other physical parameters of the mobile cart 101. In one embodiment, one or more of the wheels 104 or similar mechanisms can include a locking and/or braking device 105.

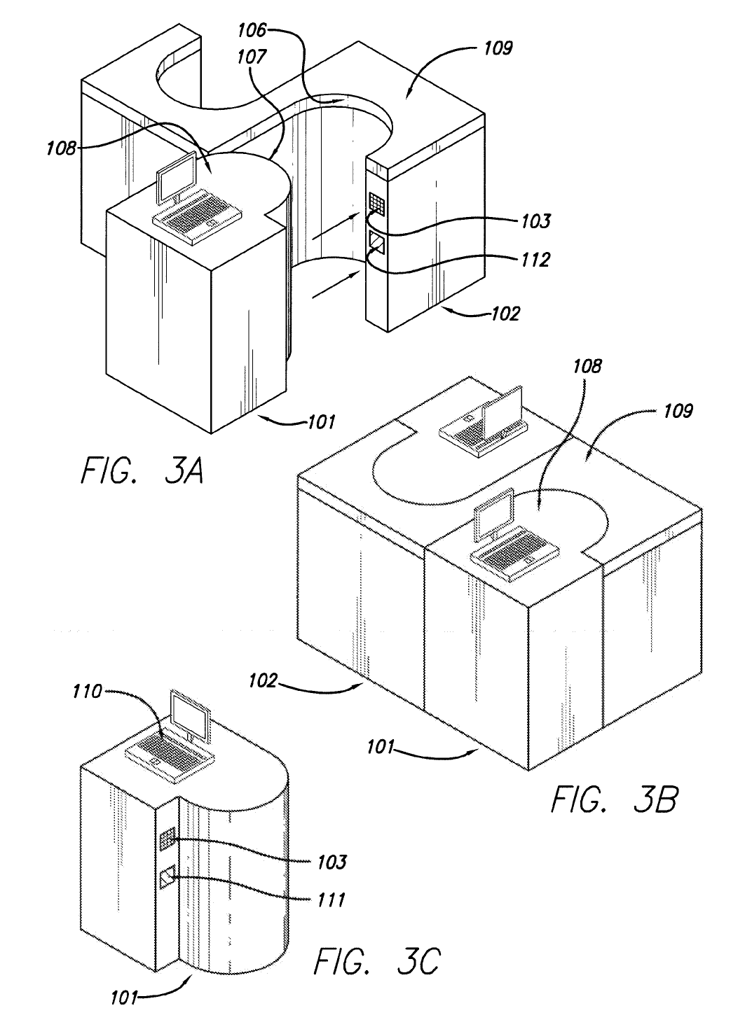

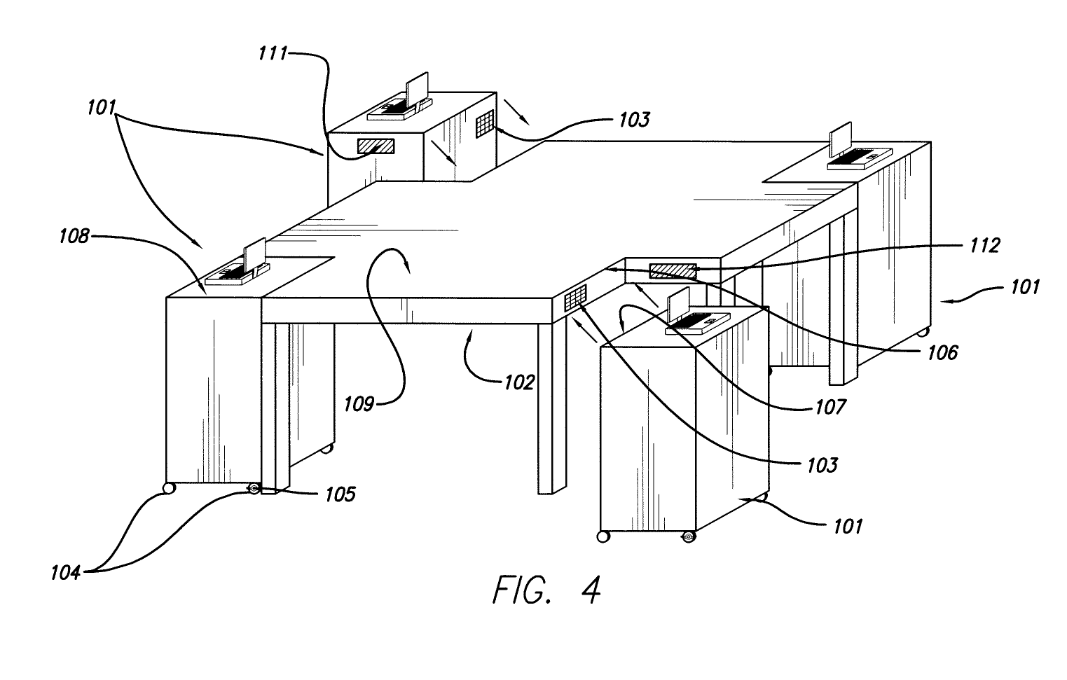

In one embodiment, the stationary item of furniture 102 may be configured to receive the mobile cart 101. The stationary item of furniture 102 may have one or more components 106 specifically configured to physically interact with the mobile cart 101. By way of example, one or more components of the stationary item of furniture 102 may include contours 106 that are complementary to the contours 107 of the mobile cart 101. Thus, when brought into close physical proximity to one another and oriented in the proper manner, the mobile cart 101 and stationary item of furniture 102 interact with one another. In one embodiment, for instance, this creates a substantially unitary counter or desktop surface between a surface portion 108 of the mobile cart 101 and a surface portion 109 of the stationary item of furniture 102. When oriented in such a manner, one or more devices 103 to removably secure the mobile cart 101 to the stationary item of furniture 102 can be engaged to secure the mobile cart 101 to the stationary item of furniture 102. In another embodiment, the stationary item of furniture 102 may be configured to interact with one or more other stationary items of furniture. In another embodiment, as depicted in FIGS. 3 and 4, the stationary item of furniture 102 may be configured to receive a plurality of mobile carts 101.

In one embodiment, as depicted in FIG. 3, the present invention provides a system for saving space, comprising a stationary item of furniture 102 adapted to interact with one or more mobile carts 101, wherein a rectangular and/or cubic configuration is created when the mobile carts 101 are brought in close proximity to the stationary item of furniture 102 and oriented in the proper manner. In this manner, space is conserved when one or more mobile carts 101 are docked to the stationary item of furniture 102.

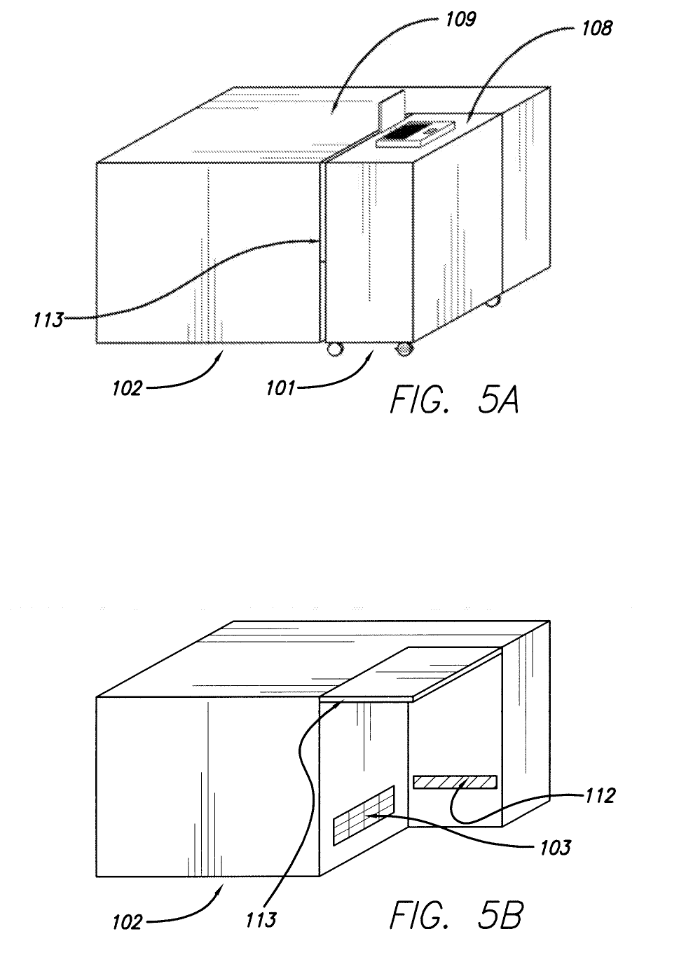

In one embodiment, as depicted in FIG. 5, the stationary item of furniture 102 includes a countertop portion 113 that remains substantially hidden from view when the mobile cart 101 is docked to the stationary item of furniture 102, but which moves from its hidden position to either partially or entirely replace the surface portion 108 of the mobile cart 101 when the mobile cart 101 is removed from the stationary item of furniture 102. As will be readily appreciated by those of skill in the art, any number of hinges, springs or other mechanical elements can be used to enable the movement of the countertop portion 113 between the aforementioned positions, and to lock it in place in either such position. In this manner, the removal of the mobile cart 101 does not result in a sacrifice of counter space. The configuration of the movable countertop portion 113 can be selected from any desirable configuration, depending upon, among other things, the design of the stationary item of furniture 102 and/or the mobile cart 101.

Any number of items may be configured on the mobile cart 101. In one embodiment of the present invention, a computer 110 resides on the mobile cart 101. The computer 110 can be a desktop, laptop or any other type of computer. In alternate embodiments, other items of equipment useful in a healthcare setting may be included on the mobile cart; for example, patient monitoring equipment, equipment useful in performing surgical procedures, and the like. It will be readily apparent to those of skill in the art that, depending upon the setting in which the invention is implemented, a large variety of equipment or other items may be included on or in the cart.

The mobile cart 101 may include one or more units 111 configured to removably interact with one or more corresponding receivers 112 on the stationary item of furniture 102. In one embodiment, the units 111 and the receivers 112 are configured to interact when the mobile cart 101 and stationary item of furniture 102 are secured to one another. The units 111 may include, but are in no way limited to, a power plug to provide electricity to the computer 110 or to any other item configured on or in the cart that may require or make use of an external power supply, a network adapter to provide electronic communication between the computer 110 or any other item configured on or in the cart that may require or make use of a network connection, and/or a telephone connector to provide telephonic communication between the computer 110 or any other item configured on or in the cart that may require or make use of a telephonic connection. The stationary item of furniture 102 may include, for each of the aforementioned units 111, a corresponding power socket or similar receiver, a corresponding network jack or similar receiver and a corresponding telephone jack or similar receiver. The aforementioned network and telephone connections may be established entirely or partially via wireless technology in an alternate embodiment of the present invention; in such embodiments, physical connections may not need to be established between the electronic components on the mobile cart 101 and the stationary item of furniture 102. Still further units that may be useful in connection with alternate embodiments of the present invention will be readily apparent to those of skill in the art and can be implemented without undue experimentation; for instance, but in no way limited to, to enable the connection of an item configured on or in the mobile cart with an external water, oil or gas supply line.

### EXAMPLE

The following example is provided to better illustrate the invention and is not to be interpreted as limiting the scope of the invention. To the extent that specific materials are mentioned, it is merely for purposes of illustration and is not intended to limit the invention. One skilled in the art may develop equivalent means without the exercise of inventive capacity and without departing from the scope of the invention.

A mobile cart includes four wheels and has a computer system (e.g., a monitor, a central processing unit, and user interface devices including a keyboard and mouse) upon it. It is contoured to removably mate with a stationary desk and cabinets that is built into the wall located outside a suite of patient rooms in a hospital. The mobile cart includes several clasps to removably secure the mobile cart to the desk/cabinets assembly. The mobile cart additionally includes three wheels; one wheel includes a locking and braking mechanism.

In operation, the mobile cart is in one of several locations: (1) secured to the stationary desk/cabinets assembly, (2) removed from the stationary desk/cabinets assembly and rolled into any of the patient rooms in the suite of patient rooms outside of which the desk/cabinets assembly is located, or (3) transported away from the suite of patient rooms altogether for use in another location. The locking and braking mechanism may be used to maintain the position of the mobile cart when it is not secured to the desk/cabinets assembly.

Various embodiments of the invention are described above in the Description of the Invention. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s).

The foregoing description of various embodiments of the invention known to the applicant at this time of filing the application has been presented and is intended for the purposes of illustration and description. The present description is not intended to be exhaustive nor limit the invention to the precise form disclosed and many modifications and variations are possible in the light of the above teachings. The embodiments described serve to explain the principles of the invention and its practical application and to enable others skilled in the art to utilize the invention in various embodiments and with various modifications as are suited to the particular use contemplated. Therefore, it is intended that the invention not be limited to the particular embodiments disclosed for carrying out the invention.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

What is claimed is:

1. A mobile cart adapted to interlock with an item of stationary furniture.

2. The mobile cart of claim 1, wherein said item of stationary furniture is a desk, cabinet, bookcase, credenza, table, and/or countertop.

3. The mobile cart of claim 1, adapted to interlock with one or more other mobile carts.

4. The mobile cart of claim 1, further comprising one or more wheels.

5. The mobile cart of claim 4, further comprising one or more wheel locking and/or braking devices.

6. The mobile cart of claim 1, further comprising an interlocking device to removably secure the mobile cart to the item of stationary furniture.

7. The mobile cart of claim 6, wherein said interlocking device is a lock, a clasp, a hook and eye, a snap, and/or a hook and loop system.

8. The mobile cart of claim 1, wherein said item of stationary furniture is configured to receive the mobile cart.

9. The mobile cart of claim 1, configured to create a unitary desktop surface when interlocked with one or more other mobile carts and/or with the item of stationary furniture.

10. The mobile cart of claim 9, wherein a rectangular and/or cubic configuration is formed when said item of stationary furniture is interlocked with the mobile cart.

11. The mobile cart of claim 1, further comprising one or more units configured to removably interact with one or more corresponding receivers on the item of stationary furniture.

12. The mobile cart of claim 11, wherein the unit is a power plug to provide electricity to a device on the mobile cart and the corresponding receiver is power socket, wherein the unit is a network adapter to enable electronic communication with a device on the mobile cart and the corresponding receiver is a network jack, and/or wherein the unit is a telephone connector to enable telephonic communication with a device on the mobile cart and the corresponding receiver is a telephone jack.

13. An item of stationary furniture adapted to interlock with a mobile cart.

14. The item of stationary furniture of claim 13, wherein said item of stationary furniture is a desk, cabinet, bookcase, credenza, table, and/or countertop.

15. The item of stationary furniture of claim 13, further comprising an interlocking device to removably secure the item of stationary furniture to the mobile cart.

16. The item of stationary furniture of claim 15, wherein said interlocking device is a lock, a clasp, a hook and eye, a snap, and/or a hook and loop system.

17. The item of stationary furniture of claim 13, configured to create a unitary desktop surface when interlocked with the mobile cart.

18. The item of stationary furniture of claim 13, wherein a rectangular and/or cubic configuration is formed when said item of stationary furniture is interlocked with the mobile cart.

19. The item of stationary furniture of claim 13, further comprising one or more receivers configured to removably interact with one or more corresponding units on the mobile cart.

20. The item of stationary furniture of claim 19, wherein the receiver is power socket and the corresponding unit is a power plug to provide electricity to a device on the mobile cart, wherein the receiver is a network jack and the corresponding unit is a network adapter to enable electronic communication with a device on the mobile cart, and/or wherein the receiver is a telephone jack and the corresponding unit is a telephone connector to enable telephonic communication with a device on the mobile cart.

21. A system, comprising:
a mobile cart;
an item of stationary furniture; and
a computer or item of equipment useful in a healthcare setting,
wherein the mobile cart is configured to interlock with the item of stationary furniture through an interlocking device, and the computer or item of equipment useful in a healthcare setting is configured in or on the mobile cart.

22. The system of claim 32, wherein the item of equipment useful in a healthcare setting is patient monitoring equipment or equipment used in performing a surgical procedure.
